(19) United States
(12) Patent Application Publication
(10) Pub. No.: US 2016/0347985 A1
(43) Pub. Date: Dec. 1, 2016

(54) FLUIDS AND METHODS FOR TREATING HYDROCARBON-BEARING FORMATIONS

(71) Applicants: Leiming Li, Sugar Land, TX (US); Jia Zhou, Cypress, TX (US); Hong Sun, Houston, TX (US); Harold D. Brannon, Magnolia, TX (US); Magnus Legemah, Cypress, TX (US)

(72) Inventors: Leiming Li, Sugar Land, TX (US); Jia Zhou, Cypress, TX (US); Hong Sun, Houston, TX (US); Harold D. Brannon, Magnolia, TX (US); Magnus Legemah, Cypress, TX (US)

(73) Assignee: Baker Hughes Incorporated, Houston, TX (US)

(21) Appl. No.: 15/153,870

(22) Filed: May 13, 2016

Related U.S. Application Data
(60) Provisional application No. 62/169,199, filed on Jun. 1, 2015.

(51) Int. Cl. C09K 8/512; E21B 43/26; E21B 33/138; C09K 8/502

(52) U.S. Cl. CPC C09K 8/512; C09K 8/502; E21B 43/26; E21B 33/138; C09K 2208/24; C09K 2208/26; E21B 43/267

(57) ABSTRACT

A fluid for temporarily plugging a hydrocarbon-bearing formation is disclosed. The fluid includes a carrier fluid and a crosslinked synthetic polymer, wherein the polymer comprises a labile group to degrade the polymer when exposed to a change in a condition of the fluid.

### CROSS REFERENCE TO RELATED APPLICATIONS

This application claims the benefit of an earlier filing date from U.S. Provisional Application Ser. No. 62/169,199 filed Jun. 1, 2015, the entire disclosure of which is incorporated herein by reference.

### BACKGROUND

Hydraulic fracturing is a process by which cracks or fractures in a subterranean zone are created by pumping a fracturing fluid at a pressure that exceeds the parting pressure of the rock. The fracturing fluid creates or enlarges fractures in the subterranean zone and a particulate proppant material suspended in the fracturing fluid may be pumped into the created fracture. The created fracture continues to grow as more fluid and proppant are introduced into the formation. The proppants remain in the fractures in the form of a permeable “pack” that serves to hold or “prop” the fractures open. The fracturing fluid can be “broken” and recovered by adding a breaking agent or using a delayed breaker system already present in the fracturing fluid to reduce the viscosity of the fracturing fluid. Reduction in fluid viscosity along with fluid leak-off from the created fracture into permeable areas of the formation allows for the fracture to close on the proppants following the treatment. By maintaining the fracture open, the proppants provide a highly conductive pathway for hydrocarbons and/or other formation fluids to flow into the borehole.

There are a number of procedures and applications in a hydraulic fracturing process that involve the formation of a temporary plug while other steps or processes are performed, where the plug must be later removed. Often such plugs are provided to temporarily block a flow pathway or inhibit the movement of fluids or other materials, such as flowable particulates, water, or gas, in a particular direction for a period of time, when later movement or flow is desirable. It is therefore desirable to provide a material for a temporary plug in a hydraulic fracturing operation which can be precisely placed within a fracture, easily broken, and subsequently removed from a hydrocarbon-bearing formation.

### BRIEF DESCRIPTION

A fluid for temporarily plugging a hydrocarbon-bearing formation is disclosed, the fluid comprising a carrier fluid, and a crosslinked synthetic polymer, wherein the polymer comprises a labile group to degrade the polymer when exposed to a change in a condition of the fluid.

Another embodiment is a temporary plug comprising the above-described fluid.

Another embodiment is a method for temporarily plugging at least a portion of a hydrocarbon-bearing formation, the method comprising injecting the fluid into the formation during a treatment, forming a temporary plug comprising the fluid, subjecting the temporary plug to a condition that results in breaking the fluid, and recovering the broken fluid.

The above described and other features are exemplified by the following Detailed Description.

### DETAILED DESCRIPTION

Described herein is a fluid for temporarily plugging a hydrocarbon-bearing formation that includes a crosslinked synthetic polymer and a carrier fluid. The crosslinked polymer initially increases the viscosity of the fluid, and is useful as a temporary plug in various treatments of a hydrocarbon-bearing formation, for example in diversion or water and/or gas shut off. In an advantageous feature, the synthetic polymer is “self-breaking,” i.e., does not require an external breaking additive in order to break, although an external breaking additive can be used. The breaking can occur over time, or with a change in condition of the fluid when the polymer is self-breaking, for example, a change in temperature, as described below in further detail. This feature allows for more precise placement of the fluid and ready removal after breaking. Crosslinking the synthetic polymer allows for further tuning of the fluid system described herein, where the fluids can be tailored to suit a various applications where different rates of polymer breakage are desired.

Accordingly, the synthetic polymer used in the fluid has a number of advantageous features. The polymer is a synthetic, or man-made, polymer. It is thus not subject to availability fluctuations as is the case with some natural polymers.

The synthetic polymer is further highly soluble in aqueous carrier fluids, for example an aqueous medium such as water or slickwater. Rapid solubility allows a rapid increase in the viscosity of the fluid upon mixing with the polymer. The polymer accordingly comprises a polymer backbone comprising units derived by polymerization of (meth)acrylamide, N-(C₁-C₈ alkyl)(meth)acrylamide, N,N-di(C₁-C₈ alkyl) (meth)acrylamide, vinyl alcohol, allyl alcohol, vinyl acetate, acrylonitrile, (meth)acrylic acid, ethacrylic acid, α-chloroacrylic acid, β-cyanoacrylic acid, β-methylacrylic acid (crotonic acid), α-phenylacrylic acid, β-acryloyloxypropionic acid, maleic acid, maleic anhydride, fumaric acid, itaconic acid, sorbic acid, α-chlorosorbic acid, 2′-methylisocrotonic acid, 2-acrylamido-2-methylpropane sulphonic acid, allyl sulphonic acid, vinyl sulphonic acid, allyl phosphonic acid, vinyl phosphonic acid, a corresponding salt of any of the foregoing monomers (e.g., sodium acrylate), (C₁₋₃ alkyl) (meth)acrylate, (hydroxy-C₁₋₆ alkyl) (meth)acrylate, (dihydroxy-C₁₋₆ alkyl) (meth)acrylate, (trihydroxy-C₁₋₆ alkyl) (meth)acrylate, diallyl dimethyl ammonium chloride, N,N-di-(C₁₋₆ alkyl)amino (C₁₋₆ alkyl) (meth)acrylate, 2-ethyl-2-oxazoline, (meth)acryloxy(C₁₋₆ alkyl) tri(C₁₋₆ alkyl)ammonium halide), 2-vinyl-1-methylpyridinium halide), 2-vinylpyridine N-oxide), 2-vinylpyridine, or a combination comprising at least one of the foregoing.

Specific examples of the foregoing include acrylamide, methacrylamide, N-methylacrylamide, N-methylmethacrylamide, N,N-dimethylacrylamide, N-ethylacrylamide, N,N-diethylacrylamide, N-cyclohexylacrylamide, N-benzylacrylamide, N,N-dimethylaminopropylacrylamide, N,N-dimethylaminoethylacrylamide, N-tert-butyl acrylamide, N-vinylformamide, N-vinylacetamide, acrylonitrile, methacrylonitrile, vinyl alcohol, a combination of acrylamide and acrylic acid, diallyl dimethyl ammonium chloride, 1-glycerol (meth)acrylate, 2-dimethylaminoethyl (meth)acrylate), 2-hydroxyethyl methacrylate, a combination of 2-hydroxyethyl methacrylate and methacrylic acid), 2-hydroxypropyl methacrylate, 2-methacryloxyethyl trimethyl ammonium bromide), 2-vinylpyridine), and 3-chloro-2-hydroxypropyl-2-methacryloxyethyl dimethyl ammonium chloride.

Units that do not impart water solubility to the polymer can also be present in the polymer, provided that the type and amount of such units do not significantly adversely affect the intended function of the polymer, in particular its water solubility. Non-limiting examples of such hydrophobic units include (C₃₋₁₆ alkyl) (meth)acrylate, (meth)acrylonitrile, styrene, alpha-methyl styrene, ethylene, isoprene, butadiene, and the like. In an embodiment, the polymers comprise less than 25 mole % of such units, or are devoid of such units.

When the synthetic polymer comprises hydrophobic units, the amount and type of units are selected to provide the polymer with a solubility parameter that is proximate to that of the carrier fluid so that the polymer can rapidly dissolve in the carrier fluid. The selection of units can be determined, in part, using the Hildebrand solubility parameter of the chemical constituents, a numerical parameter that indicates the relative solvency behavior in a specific solvent (here the carrier fluid). By tailoring the polymer structure (e.g., by combining appropriate amounts of hydrophilic units with hydrophobic units) the solubility parameter of the polymer can be tailored to be proximate to that of a particular carrier fluid. The solubility parameter of the polymer can be calculated based on the relative weight fractions of each constituent of the polymer according to equation (1):

δ_{polymer}=w₁δ₁+w₂δ₂ (1)

where δ_{polymer} is the Hildebrand solubility parameter of the copolymer, δ₁ is the solubility parameter the hydrophilic polymer units, w₁ is the weight fraction of the hydrophilic polymer units, δ₂ is the solubility parameter of the hydrophobic polymer units, and w₂ is the weight fraction of the hydrophobic polymer units. In an embodiment, the calculated solubility parameter of the polymer is within about 25% of the solubility parameter of the carrier fluid, or within about 15% of the solubility parameter of the carrier fluid.

The synthetic polymer can be a homopolymer or copolymer, including a block copolymer, an alternating block copolymer, a random copolymer, a random block copolymer, a graft copolymer, or a star block copolymer. It can further be ionomeric. The polymer can be a linear, branched, or crosslinked. In some embodiments, the polymer is a crosslinked polymer.

A combination of two or more polymers can be used. For example, the fluid can comprise a first synthetic polymer as described above and a second polymer that are blended together or that are copolymerized together. The copolymerization may involve covalent bonding and/or ionic bonding. The second polymer can be synthetic or natural, and hydrophobic or hydrophilic, provided that the resulting polymer composition is soluble in the carrier fluid.

Examples of synthetic hydrophobic polymers include polyacetals, polyolefins, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyphthalimides, polyanhydrides, polyvinyl ethers, polyvinyl thioethers, polyvinyl ketones, polyvinyl halides, polyvinyl nitriles, polyvinyl esters, polysulfonates, polysulfides, polythioesters, polysulfonamides, polyureas, polyphosphazenes, polysilazanes, polyethylene terephthalate, polybutylene terephthalate, polyurethane, polytetrafluoroethylene, polychlorotrifluoroethylene, polyvinylidene fluoride, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, and polysiloxanes. A combination comprising at least one of the foregoing can be used. In an embodiment, the polymer compositions are devoid of any of the foregoing synthetic hydrophobic polymers, except where such polymers are used for another purpose, such as a coating for a proppant.

A “naturally occurring” polymer is one that is derived from a living being including an animal, a plant, and a microorganism. Examples of naturally occurring polymers can include polysaccharides, derivatives of polysaccharides (e.g., hydroxyethyl guar (HEG), carboxymethyl guar (CMG), carboxyethyl guar (CEG), carboxymethyl hydroxypropyl guar (CMHPG)), cellulose, cellulose derivatives (e.g., hydroxyethylcellulose (HEC), hydroxypropylcellulose (HPC), carboxymethylcellulose (CMC), carboxyethylcellulose (CEC), carboxymethyl hydroxyethyl cellulose (CMHEC), carboxymethyl hydroxypropyl cellulose (CMHPC)), karaya, locust bean, pectin, tragacanth, acacia, carrageenan, alginates (e.g., salts of alginate, propylene glycol alginate, and the like), agar, gellan, xanthan, scleroglucan, or a combination comprising at least one of the foregoing. In some embodiments, the polymer compositions are devoid of a natural polymer, for example devoid of guar.

Where a combination of hydrophilic and hydrophobic polymers is used, the calculated solubility parameter of the polymer blend is within about 25% of the solubility parameter of the carrier fluid, or within about 15% of the solubility parameter of the carrier fluid. The solubility parameter of the polymer blend can be calculated according to equation (2)

δ_{polymer}=w₁δ₁+w₂δ₂ (2)

where δ_{polymer} is the Hildebrand solubility parameter of the polymer blend, δ₁ is the solubility parameter the hydrophilic polymer, w₁ is the weight fraction of the hydrophilic polymer, δ₂ is the solubility parameter of the hydrophobic polymer, and w₂ is the weight fraction of the hydrophobic polymer.

In some embodiments, the polymer is desirably a crosslinked polymer, and can be crosslinked before or during a fracturing operation. For example, the polymer can be co-polymerized with crosslinkable units and the crosslinkable units are crosslinked during a fracturing operation. In some embodiments, a crosslinker is added to the fluid to crosslink the synthetic polymer. Crosslinking is, for example, through covalent bonds, ionic bonds, hydrogen bonds, metallic bonds, or a combination comprising at least one of the foregoing. Crosslinking the polymer can further increase the viscosity of the resulting fracturing fluid, trap proppant materials, prevent settling of proppant materials, and allow for formation of a temporary plug in a hydrocarbon-bearing formation.

The crosslinker can be metallic or organic. Exemplary organic crosslinkers include a di(meth)acrylamide of a diamine such as a diacrylamide of piperazine, a C₁₋₈ alkylene bisacrylamide such as methylene bisacrylamide and ethylene bisacrylamide, an N-methylol compounds of an unsaturated amide such as N-methylol methacrylamide or N-methylol acrylamide, a (meth)acrylate esters of a di-, tri-, or tetrahydroxy compound such as ethylene glycol diacrylate, poly(ethyleneglycol) di(meth)acrylate, trimethylopropane tri(meth)acrylate, ethoxylated trimethylol tri(meth)acrylate, glycerol tri(meth)acrylate), ethoxylated glycerol tri(meth)acrylate, pentaerythritol tetra(meth)acrylate, ethoxylated pentaerythritol tetra(meth)acrylate, butanediol di(meth)acrylate), a divinyl or diallyl compound such as allyl (meth)acrylate, alkoxylated allyl(meth)acrylate, diallylamide of 2,2′-azobis(isobutyric acid), triallyl cyanurate, triallyl isocyanurate, maleic acid diallyl ester, polyallyl esters, tetraallyloxyethane, triallylamine, and tetraallylethylene diamine, a polyol, hydroxyallyl or acrylate compounds, and allyl esters of phosphoric acid or phosphorous acid; water soluble diacrylates such as poly(ethylene glycol) diacrylate (e.g., PEG 200 diacrylate or PEG 400 diacrylate); phenolic compounds, phenol-generating compounds, (e.g., phenyl acetate, hydroquinone, phenol, polyphenols) and aldehydes, aldehyde-containing, or aldehyde-generating compounds (e.g., hexamethylenetetramine). A combination comprising any of the above-described crosslinkers can also be used. In some embodiments, the crosslinker comprises a phenol-generating compound (e.g., phenyl acetate) and an aldehyde-generating compound (e.g., hexamethylenetetramine). These phenol-formaldehyde crosslinkers can react with repeat units of the polymer, for example a poly(acrylamide) copolymer, providing a crosslinked polymer gel.

Non-limiting examples of metallic crosslinking agents are crosslinking agents comprising a metal such as boron, titanium, zirconium, calcium, magnesium, iron, chromium and/or aluminum, as well as organometallic compounds, complexes, ions or salts thereof, or a combination comprising at least one of the foregoing. Non-limiting examples of these metal-containing crosslinking agents include: borates, divalent ions such as Ca²⁺, Mg²⁺, Fe²⁺, Zn²⁺ and salts thereof; trivalent ions such as Al³⁺, Fe³⁺ and salts thereof; metal atoms such as titanium or zirconium in the +4 oxidation (valence) state.

The crosslinking agent can be present in the fluid in an amount of about 0.01 weight percent (wt %) to about 10 wt %, preferably about 0.02 wt % to about 1.0 wt %, based on the total weight of the fluid.

The synthetic polymer comprises a labile functionality that results in a reduction in the viscosity of the fluid with a change in a condition of the fluid. Without being bound by theory, it is believed that activation of the labile group facilitates or results in degradation of the synthetic polymer. Activation can be, for example by oxidation, reduction, photo-degradation, thermal degradation, hydrolysis, chemical degradation, or microbial degradation, depending on the labile functionality. The rate at which the degradation of the polymer occurs can be depend on, for example, type of labile group, composition, sequence, length, molecular geometry, molecular weight, stereochemistry, hydrophilicity, hydrophobicity, additives and environmental conditions such as temperature, presence of moisture, oxygen, microorganisms, enzymes, and pH of the fluid. Degradation of the labile group permits a reduction in the viscosity of the fluid or temporary plug and facilitates its removal from a fracture after the desired effect of the plug has been achieved.

The labile functionality can be water soluble groups. Labile groups can include ester groups, amide groups, carbonate groups, azo groups, disulfide groups, orthoester groups, acetal groups, etherester groups, ether groups, silyl groups, phosphazine groups, urethane groups, esteramide groups, etheramide groups, anhydride groups, and any derivative or combination thereof. The labile group can be derived from oligomeric or short chain molecules that include poly(anhydrides), poly(orthoesters), poly(lactic acids), poly(glycolic acids), poly(caprolactones), poly(hydroxybutyrates), polyphosphazenes, poly(carbonates), polyacetals, polyetheresters, polyesteramides, polycyanoacrylates, polyurethanes, polyacrylates, or the like, or a combination comprising at least one of the foregoing oligomeric or short chain molecules. The labile group can be derived from a hydrophilic polymeric block comprising a poly(alkylene glycol), a poly(alcohol) made by the hydrolysis of poly(vinyl acetate), a poly(vinyl pyrrolidone), a polysaccharide, a chitin, a chitosan, a protein, a poly(amino acid), a poly(alkylene oxide), a poly(amide), a poly(acid), a polyol, and any derivative, copolymer, or combination comprising at least one of the foregoing.

The polymer can be prepared by any of the methods well known to those skilled in the art. For example, the polymer can be manufactured by emulsion (or inverse emulsion) polymerization to obtain high molecular weights. In emulsion or inverse emulsion polymerization, the polymer is suspended in a fluid. The fluid in which the polymer is suspended can be water. The manufacturing and use of the polymer in emulsion form makes possible use as a liquid additive, simplifying its use in the fluid.

The polymer can have a number average molecular weight (Mₙ) of about 2,000,000 to about 25,000,000 grams per mole (g/mol), specifically about 10,000,000 to about 20,000,000 g/mol.

In an exemplary embodiment, the polymer used in the fluid is a polyacrylamide. A commercially available synthetic polymer having labile groups and comprising polyacrylamides is MaxPerm-20® and MaxPerm-20A®, available from Baker Hughes, Inc. In some embodiments, the polymer used in the fluid is a superabsorbent polymer.

The polymer is present in the fluid in an amount of about 0.01 to about 20 weight percent (wt %), preferably about 0.05 to about 10 wt %, and more preferably about 0.1 to about 5 wt %, based on the total weight of the fluid.

The fluid further comprises a carrier fluid. The carrier fluid can be an aqueous carrier fluid or a non-aqueous carrier fluid. The carrier fluid is generally suitable for used in hydrocarbon (i.e., oil and gas) producing wells, for example, water, or slickwater. In some embodiments, the carrier fluid solvates the polymer and transports the proppant materials downhole to the hydrocarbon bearing formation. In some embodiments, the polymer and the carrier fluid form a slurry, for example when the carrier fluid is a non-aqueous carrier fluid.

The fluid can be a slurry, a gel (e.g., a hydrogel), an emulsion, or a foam. As used herein, the term “emulsion” refers to a mixture of two or more normally immiscible liquids forming a two-phase colloidal system wherein a liquid dispersed phase is dispersed in a liquid continuous phase. For example, the fluid can be an oil-in-water emulsion. As used herein, the term “slurry” refers to a thick suspension of solids in a liquid. As used herein, the term “gel” refers to a solid, jelly-like material. The solid-like behavior of a gel is the result of the formation of a three-dimensional crosslinked network within the liquid wherein the liquid molecules are dispersed in a discontinuous phase within a solid continuous phase. A gel can be mostly liquid. The fluid can also be a gelled slurry.

Water is generally a major component by total weight of an aqueous carrier fluid. The aqueous carrier fluid can be fresh water, brine (including sea water), an aqueous acid, for example a mineral acid or an organic acid, an aqueous base, or a combination comprising at least one of the foregoing. The brine can be, for example, seawater, produced water, completion brine, or a combination comprising at least one of the foregoing. The properties of the brine can depend on the identity and components of the brine. Seawater, for example, can contain numerous constituents including sulfate, bromine, and trace metals, beyond typical halide-containing salts. Produced water can be water extracted from a production reservoir (e.g., hydrocarbon reservoir) or produced from the ground. Produced water can also be referred to as reservoir brine and contain components including barium, strontium, and heavy metals. In addition to naturally occurring brines (e.g., seawater and produced water), completion brine can be synthesized from fresh water by addition of various salts for example, NaCl, KCl, NaBr, MgCl₂, CaCl₂, CaBr₂, ZnBr₂, NH₄Cl, sodium formate, cesium formate, and combinations comprising at least one of the foregoing. The salt can be present in the brine in an amount of about 0.5 to about 50 weight percent (wt. %), specifically about 1 to about 40 wt. %, and more specifically about 1 to about 25 wt. %, based on the weight of the fracturing fluid. The carrier fluid can be recycled fracturing fluid water or its residue. In an embodiment the aqueous carrier fluid is slickwater, having, for example, a viscosity of 1 to 3 centipoise at 20° C.

The aqueous carrier fluid can be an aqueous mineral acid such as hydrochloric acid, nitric acid, phosphoric acid, sulfuric acid, boric acid, hydrofluoric acid, hydrobromic acid, perchloric acid, or a combination comprising at least one of the foregoing. The fluid can be an aqueous organic acid that includes a carboxylic acid, sulfonic acid, or a combination comprising at least one of the foregoing. Exemplary carboxylic acids include formic acid, acetic acid, chloroacetic acid, dichloroacetic acid, trichloroacetic acid, trifluoroacetic acid, propionic acid, butyric acid, oxalic acid, benzoic acid, phthalic acid (including ortho-, meta- and para-isomers), and the like. Exemplary sulfonic acids include a C₁₋₂₀ alkyl sulfonic acid, wherein the alkyl group can be branched or unbranched and can be substituted or unsubstituted, or a C₃₋₂₀ aryl sulfonic acid wherein the aryl group can be monocyclic or polycyclic, and optionally comprises 1 to 3 heteroatoms (e.g., N, S, or P). Alkyl sulfonic acids can include, for example, methane sulfonic acid. Aryl sulfonic acids include, for example, benzene sulfonic acid or toluene sulfonic acid. In some embodiments, the aryl group can be C₁₋₂₀ alkyl-substituted, i.e., is an alkylarylene group, or is attached to the sulfonic acid moiety via a C₁₋₂₀ alkylene group (i.e., an arylalkylene group), wherein the alkyl or alkylene can be substituted or unsubstituted.

In an embodiment, the carrier fluid is a non-aqueous carrier fluid. A non-aqueous carrier fluid comprises non-volatile aliphatic and aromatic hydrocarbons and mixtures thereof as generally known. Exemplary non-aqueous carrier fluids include, but are not limited to, kerosene, paraffin oil, mineral oil, crude oil, crude oil distillates, vegetable oils, silicone oils, halogenated solvents, ester alcohols, C₆₋₁₂ primary, secondary and tertiary alcohols, glycol ethers, glycols (e.g., polypropylene glycol having a molecular weight greater than 1000 Daltons), animal oils, turpentine, diesel oil, and combinations comprising at least one of the foregoing. In an exemplary embodiment, the non-aqueous carrier is mineral oil. In some embodiments, a non-aqueous carrier fluid can further comprise a suspension agent to maintain the polymer in a highly dispersed and suspended state within the non-aqueous carrier without significant settling or separation of polymer.

As described above, the synthetic polymer is preferably a highly water soluble polymer. As such, the dispersion of hydrophilic, hydratable polymer, which in an aqueous carrier fluid would inherently result in a buildup of viscosity, in a hydrophobic, non-aqueous environment results in suppressed hydration and minimum viscosity rise. Consequently the fluid comprising a non-aqueous carrier fluid remains readily pumpable and builds viscosity only upon admixing with water, aqueous brine or the like. The delay time to achieve complete hydration when a non-aqueous carrier is employed can range from minutes to hours or days and can be controlled by adjusting the amount of the superabsorbent polymer, the crosslinker type, the crosslinker concentration, the amount of aqueous fluid added to the slurry, and the time delay in adding the aqueous fluid to the slurry. For example, the delay time can be 5 minutes to 48 hours, for example 15 minutes to 24 hours, for example 30 minutes to 12 hours, for example 1 hour to 6 hours.

This feature can advantageously be used when the fluid is to be used in a diversion treatment. For example, hydration of a synthetic polymer is delayed when the polymer is injected as a slurry in mineral oil. Following injection of the slurry, an aqueous fluid is injected to initiate hydration and crosslinking of the polymer in permeable zone, forming a temporary plug due to the viscosity increase. The plug can desirably impede the flow of a subsequently injected fracturing fluid, such that the surface area of a fracture is increased. The plug can be broken after completion of the diversion treatment, for example, by injection of an aqueous fluid having a low pH (e.g., pH of about 1-5). The broken fluid can be removed from the fracture.

The fluid can comprise the carrier fluid in an amount of about 90 to about 99.95 wt %, based upon the total weight of the fracturing fluid. For example, the fracturing fluid can comprise the carrier fluid in an amount of about 95 to about 99.9 wt %, specifically about 99 to about 99.5 wt %, based on the total weight of the fluid.

A proppant can optionally further be included in the fluids disclosed herein, in an amount of about 0.01 to about 60 wt %, or about 0.1 to about 40 wt %, or about 0.1 to about 12 wt %, based on the total weight of the fracturing fluid. Suitable proppants are known in the art and can be a relatively lightweight or substantially neutrally buoyant particulate material or a mixture comprising at least one of the foregoing. Such proppants can be chipped, ground, crushed, or otherwise processed. By “relatively lightweight” it is meant that the proppant has an apparent specific gravity (ASG) that is substantially less than a conventional proppant employed in hydraulic fracturing operations, for example, sand or having an ASG similar to these materials. Especially preferred are those proppants having an ASG less than or equal to 3.25. Even more preferred are ultra-lightweight proppants having an ASG less than or equal to 2.40, more preferably less than or equal to 2.0, even more preferably less than or equal to 1.75, most preferably less than or equal to 1.25 and often less than or equal to 1.05.

The proppant can comprise sand, glass beads, walnut hulls, metal shot, resin-coated sands, intermediate strength ceramics, sintered bauxite, resin-coated ceramic proppants, plastic beads, polystyrene beads, thermoplastic particulates, thermoplastic resins, thermoplastic composites, thermoplastic aggregates containing a binder, synthetic organic particles including nylon pellets and ceramics, ground or crushed shells of nuts, resin-coated ground or crushed shells of nuts, ground or crushed seed shells, resin-coated ground or crushed seed shells, processed wood materials, porous particulate materials, and combinations comprising at least one of the foregoing. Ground or crushed shells of nuts can comprise shells of pecan, almond, ivory nut, brazil nut, macademia nut, or combinations comprising at least one of the foregoing. Ground or crushed seed shells can include fruit pits, and can comprise seeds of fruits including plum, peach, cherry, apricot, and combinations comprising at least one of the foregoing. Ground or crushed seed shells can further comprise seed shells of other plants including maize, for example corn cobs and corn kernels. Processed wood materials can comprise those derived from woods including oak, hickory, walnut, poplar, and mahogany, and includes such woods that have been processed by any means that is generally known including grinding, chipping, or other forms of particulization. A porous particulate material can be any porous ceramic or porous organic polymeric material, and can be natural or synthetic. The porous particulate material can further be treated with a coating material, a penetrating material, or modified by glazing.

The proppant can be coated, for example, with a resin or polymer. Individual proppant particles can have a coating applied thereto. If the proppant particles are compressed during or subsequent to, for example, fracturing, at a pressure great enough to produce fine particles therefrom, the fine particles remain consolidated within the coating so they are not released into the formation. It is contemplated that fine particles decrease conduction of hydrocarbons (or other fluid) through fractures or pores in the fractures and are avoided by coating the proppant. Coatings for the proppant can include cured, partially cured, or uncured coatings of, for example, a thermosetting or thermoplastic polymer. Curing the coating on the proppant can occur before or after disposal of the hydraulic fracturing fluid downhole, for example.

The coating can be an organic compound such as epoxy, phenolic, polyurethane, polycarbodiimide, polyamide, polyamide imide, furan resins, or a combination comprising at least one of the foregoing; a thermoplastic resin such as polyethylene, acrylonitrile-butadiene styrene, polystyrene, polyvinyl chloride, fluoropolymers, polysulfide, polypropylene, styrene acrylonitrile, nylon, and phenylene oxide; or a thermoset resin such as epoxy, phenolic (a true thermosetting resin such as resole or a thermoplastic resin that is rendered thermosetting by a hardening agent), polyester, polyurethane, and epoxy-modified phenolic resin. The coating can be a combination comprising at least one of the foregoing. A curing agent for the coating can be amines and their derivatives, carboxylic acid terminated polyesters, anhydrides, phenol-formaldehyde resins, amino-formaldehyde resins, phenol, bisphenol A and cresol novolacs, phenolic-terminated epoxy resins, polysulfides, polymercaptans, and catalytic curing agents such as tertiary amines, Lewis acids, Lewis bases, or a combination comprising at least one of the foregoing.

The proppant can include a crosslinked coating. The crosslinked coating can provide crush strength, or resistance, for the proppant and prevent agglomeration of the proppant even under high pressure and temperature conditions. The proppant can have a curable coating, which cures subsurface, for example, downhole or in a fracture. The curable coating can cure under the high pressure and temperature conditions in the subsurface reservoir. Thus, the proppant having the curable coating can be used for high pressure and temperature conditions.

The coating can be disposed on the proppant by mixing in a vessel, for example, a reactor. Individual components including the proppant and polymer or resin materials (e.g., reactive monomers used to form, e.g., an epoxy or polyamide coating) can be combined in the vessel to form a reaction mixture and agitated to mix the components. Further, the reaction mixture can be heated at a temperature or at a pressure commensurate with forming the coating. The coating can be disposed on the particle via spraying for example by contacting the proppant with a spray of the coating material. The coated proppant can be heated to induce crosslinking of the coating.

The fluid can optionally further comprise other additives as are generally known and used in fracturing fluids, for example a scale inhibitor, a tracer, a buffering agent, a lubricant, a non-emulsifier, a clay stabilizer, a surfactant, a biocide, an acid, a corrosion inhibitor, a pH-adjusting agent, an emulsifier, a fluid loss control agent, a mineral, oil, alcohol, or a combination comprising at least one of the foregoing additives. Each additive can be present in the generally used amount, for example, 0.005 to 10 wt %, based on the total weight of the fluid.

In some embodiments, the fluid can further comprise a breaker package. A breaker package comprises a breaking agent, and optionally a breaker catalyst. In some embodiments, the fluid is devoid of a breaker package.

Breaking agents “break” or diminish the viscosity of the fracturing fluid so that the fracturing fluid is more easily recovered from the formation during cleanup, for example, by breaking crosslinks bridging repeat units of two or more polymer chains. Breaking agents can include oxidizers, enzymes, or acids. Breaking agents can reduce the polymer molecular weight by the action of an acid, an oxidizer, an enzyme, or some combination of these on the polymer. Breaking agents include, for example, persulfates, ammonium persulfate, sodium persulfate, potassium persulfate, bromates such as sodium bromate and potassium bromate, periodates, peroxides such as calcium peroxide, hydrogen peroxide, bleach such as sodium perchlorate and organic percarboxylic acids or sodium salts, organic materials such as enzymes and lactose, chlorites, or a combination comprising at least one of the foregoing breaking agents. Breaking agents can be introduced into the fracturing fluid “live” or in an encapsulated form to be activated by a variety of mechanisms including crushing by formation closure or dissolution by formation fluids.

The breaking agent can be used to control degradation of the polymer, for example, degradation of the crosslinked polymer in a temporary plug formed from the fluid. For example, the breaking agent can be added to the fluid to instantly begin reducing the viscosity of the fluid, or the breaking agent can be present in the fluid at the outset and can be activated by some external or environmental condition. In one embodiment, an oilfield breaking agent can be used to break the fluid using elevated temperatures downhole. For example, the breaking agent can be activated at temperatures of 50° C. or greater. In some embodiments, it is preferred that the fluid has no breaking agent, or no breaking agent is present in the fluid. In some embodiments, the temporary plug can be easily removed upon completion of the treatment by, for example, circulating a fluid containing the breaker package to degrade the plug

In general, a breaker catalyst can increase the reactivity of the breaker to facilitate complete degradation of the polymer. The catalyst can be a transition metal catalyst, for example, a complex formed from transition metals such as manganese, iron, copper, and cobalt. Alternatively, the catalyst can be an amine-containing compound, for example, triethanolamine, hydroxylamine, hydrazine, salts thereof, and the like, or a carboxylic acid-containing compound, for example, erythorbic acid, gluconic acid, citric acid, salts thereof, and the like.

The fluid can be manufactured by various methods according to general techniques which are known. For example, a method for manufacturing the fluid can comprise dissolving the polymer into the carrier fluid in an amount effective to increase the viscosity of the carrier fluid. Additives including crosslinkers, proppant, surfactants, breaking agents, and the like, can be present in the carrier fluid either prior to the addition of the polymer or can be added to the carrier fluid after the addition of the polymer. The polymer can be rapidly dissolved into the carrier fluid and increase the viscosity of the carrier fluid.

Before dissolving the synthetic polymer, the carrier fluid can have a low viscosity (e.g., a viscosity of ≦3 centipoise, measured at 20° C.). Immediately after a first period of time (i.e., immediately after dissolution), the fluid has a first viscosity. The first viscosity can be determined, for example, 5 minutes after combining the carrier fluid and the synthetic polymer. The first viscosity is increased relative to the low viscosity of the carrier fluid.

After a second period of time, subsequent to the first period of time, the viscosity of the fluid attains a maximum, referred to herein as a second viscosity. The second viscosity is higher than the first viscosity. The type and amount of the synthetic polymer and the carrier fluid is selected so as to attain the maximum second viscosity at the desired time in the subterranean formation. For example, the maximum second viscosity can be achieved in about 5 to about 50 minutes following introduction of the polymer to the carrier fluid, or about 10 to about 30 minutes. In some embodiments, the fluid forms a temporary plug when the fluid has the second viscosity.

After a third period of time subsequent to the second period of time, the viscosity of the fluid attains a third viscosity. The third viscosity is lower than the maximum second viscosity, and results from breaking of the fluid.

In some embodiments, subjecting the fluid to a breaking condition, in addition to the passage of time, can lower the third viscosity even further. Without being bound by theory, it is believed that the breaking condition enhances the degradation of the synthetic polymer. Suitable breaking conditions will depend on the type and amount of the synthetic polymer, the type and amount of crosslinker, the type of carrier, the type of additives, downhole conditions, and like considerations. Examples of breaking conditions include a change in temperature, pH, water content of the fluid, osmolality of the fluid, salt concentration of the fluid, additive concentration of the fluid, or a combination comprising at least one of the foregoing conditions.

The change in condition (the breaking condition) can be applied at any time during the first period, the second period, the third period, or any combination thereof. For example, the change in condition (the breaking condition) can be applied after the desired effect of a temporary plug has been achieved (e.g., diversion, water and/or gas shut off, and the like). When subjected to a breaking condition, the third viscosity attained is lower than the maximum second viscosity.

As will be understood by those of skill in the art, the first, second, and third viscosities can vary widely depending on the function of the fluid. For example, the second viscosity of a diverter fluid can be relatively low (just sufficient to divert the injected fluids), while the second viscosity of a water plug can be significantly higher. Those of skill in the art can adjust the type and amounts of carrier fluid, synthetic polymer, and additives to attain the desired viscosities without undue experimentation. For example, in a non-limiting embodiment, the first viscosity can be about 1 to about 20 centipoise at 20° C., or about 2 to about 15 centipoise at 20° C., or about 3 to about 12 centipoise at 20° C.; the second viscosity can be about 5 to about 50 centipoise at 20° C., or about 8 to about 40 centipoise at 20° C., or about 5 to about 30 centipoise at 20° C., measured, for example 5 minutes after mixing the fluid and the synthetic polymer; and the third viscosity can be measured, for example, at one hour after the initial mixing, and can be about 1 to about 20 centipoise at 20° C., or about 1 to about 15 centipoise at 20° C., or about 1 to about 10 centipoise at 20° C. In other exemplary, non-limiting embodiments, the viscosity of the carrier fluid can be increased by about 40% to about 900% in about 5 to about 20 minutes following introduction of the polymer to the carrier fluid, or the viscosity of the carrier fluid can increased by about 15% to about 500% in about 5 to about 20 minutes following introduction of the polymer to the carrier fluid, or the viscosity of the carrier fluid can be increased by about 50% to about 750% in about 10 to about 15 minutes following introduction of the polymer to the carrier fluid; or the maximum second viscosity at 20° C. can be about 10% to about 900% higher than the first viscosity at 20° C., or about 15% to about 500% higher than the first viscosity at 20° C., or about 20% to about 300% than the first viscosity at 20° C.; the third viscosity at 20° C. is about 10% to about 80% lower than the maximum second viscosity at 20° C., or about 15% to about 70% lower than the maximum second viscosity at 20° C., or about 20% to about 60% than the first viscosity at 20° C., e.g., the third viscosity can be about 20% to about 95% lower than the maximum second viscosity of the embodiment, for example 1 to 5 cP at 20° C., or the third viscosity of the fracturing fluid at 122° F. (50° C.) is about 20% to about 95% lower than the maximum second viscosity at 122° F. (50° C.), and is 1 to 5 cP at 122° C.

The fluid can be used to create a plug, optionally together with sand and/or other proppants, for example, in between stages during a fracturing treatment. The plugs are non-permanent (temporary) plugs that can be set very fast, and that only needs to last for as long as the stage above is being fractured. Temporary plugs inhibit or prevent the flow of fluid through the conductive pathways of a fracture. It is desirable that a temporary plug be removed when it is no longer needed, for example, the plugs can be recovered as broken fluids following exposure to any one or more of the above-described conditions to break the polymer.

Advantageously, components of the fluid can be selected to suit a desired application depending on the rate of breaking, for example the fluids can be used as a temporary blocking agent, for example as diverting agents, or for water and/or gas plugs. The temporary plugs are useful as short-term or long-term plugs by careful selection of crosslinker and breaking conditions when formulating the fluid. For example, a covalent crosslinker can be used to form relatively strong covalent crosslinks, and the resulting fluid can be used as a long-term temporary plug. In some embodiments, a long-term temporary plug can be maintained for greater than or equal to 1 day, for example, greater than or equal to 3 days, for example, greater than or equal to 1 week, for example, greater than or equal to 2 weeks, for example, greater than or equal to 1 month, for example greater than or equal to 3 months, for example greater than or equal to 6 months. For example, a crosslinker comprising a metal salt can be used to form relatively weak crosslinks, and the resulting fluid can be used as a short-term temporary plug (e.g., a diverter). A short-term temporary plug can be maintained for a period of time suitable to carry out a desired treatment (e.g., a diversion treatemtn). For example, a short-term temporary plug can be maintained for less than or equal to 24 hours, for example, less than or equal to 12 hours, for example, less than or equal to 6 hours, for example, less than or equal to 1 hour, for example, less than or equal to 30 minutes, for example, less than or equal to 15 minutes. In some embodiments, the short-term temporary plug is maintained for at least 5 minutes. The breaker can also be selected to control the rate of degradation of the crosslinks. For example, in some embodiments, the plugs can be dissolved using an acidic solution, for example, when metallic crosslinkers are employed.

In some embodiments, the fluid can be used to create temporary plugs in natural fractures during slickwater treatments. The fluid can plug a fracture to prevent fracturing fluid from migrating through a natural fracture, and subsequently self-break to allow flow through the fracture. When an acidizing treatment is required to increase the productivity of the hydrocarbon-bearing zones, the water-based stimulation fluids favor the water-bearing zone over the hydrocarbon-bearing zone due to the relative permeability effects, resulting in higher water cut. The temporary plug can divert stimulation fluids away from the water zone into the oil zone.

Also disclosed is a method for temporarily plugging at least a portion of a hydrocarbon-bearing formation during a treatment. As used herein, the term “treating” or “treatment” refers to any hydrocarbon-bearing formation operation that uses a fluid in conjunction with a desired function or purpose. The term “treatment” or “treating” does not imply any particular action by the fluid or any particular constituent thereof. Further as used herein a “borehole” is any type of well, such as a producing well, a non-producing well, an experimental well, an exploratory well, a well for storage or sequestration, and the like. Boreholes include any type of downhole fracture, and may be vertical, horizontal, some angle between vertical and horizontal, diverted or non-diverted, and combinations thereof, for example a vertical borehole with a non-vertical component. In a method for treating a hydrocarbon-bearing formation, the fracturing fluid is introduced (e.g., pumped) into the borehole.

In a method for temporarily plugging at least a portion of a hydrocarbon-bearing formation, the fluid is introduced (e.g., pumped) into the borehole during a treatment to form a temporary plug. The temporary plug can be used as, for example, a diverting agent, or for water and/or gas shut off in a hydrocarbon-bearing formation during a treatment. In an embodiment, the fluid is formulated and immediately introduced into the borehole, in particular a downhole fracture in the hydrocarbon-bearing formation. Rapid hydration of the polymer by the carrier fluid increases the viscosity of the fracturing fluid as it is pumped. In some embodiments, the carrier fluid can be pumped into the hydrocarbon-bearing formation, i.e., downhole, and the synthetic polymer and optional additives can be introduced into the carrier fluid downhole. After the desired effect of the temporary plug has been achieved, the plug is subjected to a condition that results in breaking of the plug. The broken fluid can be recovered from the hydrocarbon-bearing formation. In some embodiments, removal of the fluid from the formation leaves behind a conductive pathway. The conductive pathway permits extraction of hydrocarbons from the fracture.

At any suitable point in the process, the fluid can be subjected to a breaking condition that increases the breaking of the fluid. As described above, the condition can be the passage of time or a temperature, pH, water content of the fluid, osmolality of the fluid, salt concentration of the fluid, additive concentration of the fluid, or a combination comprising at least one of the foregoing conditions. Specifically, the change in condition facilitates degradation of the polymer, reducing viscosity of the fluid. The broken fluid can then be removed from the borehole.

The fluid described herein has a number of advantages over other commercially available polymers that are presently used in as hydrocarbon formation treatment fluids. Since the polymer is synthetic, it is not subject to some of the production constraints associated with naturally occurring polymers. It is readily hydrated, and undergoes rapid dissolution when mixed with the carrier fluid. Its use allows for the breaking of the fluid to be timed to provide maximum advantage, for example, after temporarily plugging a fracture. Additionally, the fluid can advantageously be selected to achieve a desired effect, for example through modifying the crosslinker and/or breaker used to formulate the fluid.

The invention is further illustrated by the following non-limiting examples.

### EXAMPLES

### Prophetic Example 1

A fluid for temporarily plugging a hydrocarbon-bearing formation includes water and an acrylamide copolymer comprising a labile group. The acrylamide copolymer is MaxPerm20 or MaxPerm20A, available from Baker Hughes, Inc. The fracturing fluid also includes hexamethylenetetramine (a formaldehyde-generating material), phenyl acetate (a phenol-generating material), an encapsulated or “live” breaker, a slow-release acid or a latent acid such as glyoxal, and optionally additives including surfactant, forming agent, and/or other additives.

The labile group accelerates the decomposition of the polymer in response to a condition such as time, temperature, pH, and breaker type. Depending on these conditions, the breaking speed of the crosslinked polymer can be fast or slow.

### Prophetic Example 2

A fluid for temporarily plugging a hydrocarbon-bearing formation includes water, an acrylamide copolymer, and a metallic crosslinker. The acrylamide copolymer is MaxPerm20 or MaxPerm20A, available from Baker Hughes, Inc. The metallic crosslinker is zirconium or a combination of zirconium and aluminum. The fluid is used for acidizing diversion, where the fluid is mixed with an acid having a low pH. The acidity of the fluid suppresses crosslinking. The acid can react with carbonate to neutralize the acid, and locally increase the pH of the fluid, enabling crosslinking of the polymer. Polymer crosslinking increases the fluid viscosity, and the thickened material can act as a diverter fluid. The fluid breaks over time.

### Prophetic Example 3

A fluid for temporarily plugging a hydrocarbon-bearing formation includes water and a superabsorbent polymer. An example of a preferred superabsorbent polymer is Aqualic CA QX-A1051 from Nippon Shokubai. This fluid is desirably used as a diverter fluid partially due to the pellet shape of the super absorbent polymers in the fluid. The fluid can optionally include other components for example a metallic crosslinker (e.g., zirconium), hexamethylenetetramine (a formaldehyde-generating material), phenyl acetate (a phenol-generating material), a breaker, encapsulated or “live,” a slow-release acid or a latent acid such as glyoxal, and additives such as surfactant, forming agent, and/or other additives.

### Prophetic Example 4

A fluid for temporarily plugging a hydrocarbon-bearing formation includes a superabsorbent polymer and mineral oil. The superabsorbent polymer is suspended in mineral oil to form a slurry. The fluid further includes a crosslinker (e.g., zirconium crosslinker, hexamethylenetetramine and phenyl acetate) and a breaker in encapsulated or “live” form, a slow-release acid or a latent acid such as glyoxal, and optionally additives including a suspension agent, surfactant, forming agent, and/or other additives. The oil-containing fluid is used for a diversion treatment, where the slurry is injected into a formation. The presence of the mineral oil delays hydration of the polymer. After injection of the slurry, an aqueous solution having a pH effective to initiate crosslinking is injected into the formation. The polymer becomes hydrated and crosslinked, and the viscosity is increased, forming a temporary plug in the permeable zones of the formation. Subsequently, a fracturing fluid is injected into the formation, and the flow is impeded by the presence of the temporary plug. The fracturing fluid can open new fractures or further propagate distant fractures, thereby increasing the overall surface area and/or the complexity of the fracture area. Following completion of the diversion treatment, a second aqueous fluid having a low pH (e.g., 1-5) is injected into the fracture to fully degrade the crosslinked polymer to form a broken fluid. The broken fluid is removed from the fracture during flow back.

The compositions and methods are further illustrated by the following embodiments, which are non-limiting:

### Embodiment 1

A fluid for temporarily plugging a hydrocarbon-bearing formation, the fluid comprising: a carrier fluid; and a crosslinked synthetic polymer, wherein the polymer comprises a labile group to degrade the polymer when exposed to a change in a condition of the fluid.

### Embodiment 2

The fluid of embodiment 1, wherein the carrier fluid is an aqueous carrier fluid.

### Embodiment 3

The fluid of embodiment 1, wherein the carrier fluid is a non-aqueous carrier fluid.

### Embodiment 4

The fluid of any one or more of the preceding embodiments, wherein the fluid has a first viscosity after a first period of time subsequent to mixing of the polymer and the carrier fluid, a second viscosity after a second period of time subsequent to the first period, and a third viscosity after a third period of time subsequent to the second period, wherein the second viscosity is higher than the first viscosity and the third viscosity.

### Embodiment 5

The fluid of embodiment 4, further wherein the third viscosity is less than or equal to the first viscosity.

### Embodiment 6

The fluid of embodiment 4, wherein the third viscosity is greater than or equal to the first viscosity.

### Embodiment 7

The fluid of any one or more of embodiments 4 to 6, wherein a temporary plug is formed when the fluid has the second viscosity.

### Embodiment 8

The fluid of any one or more of the preceding embodiments, wherein the fluid has a first viscosity that is greater than the viscosity of the carrier fluid.

### Embodiment 9

The fluid of any one or more of the preceding embodiments, wherein the maximum second viscosity at 20° C. is higher than the first viscosity at 20° C.

### Embodiment 10

The fluid of any one or more of the preceding embodiments, wherein the third viscosity at 20° C. is lower than the maximum second viscosity at 20° C.

### Embodiment 11

The fluid of any one or more of the preceding embodiments, wherein the change in a condition of the fluid further decreases the third viscosity.

### Embodiment 12

The fluid of embodiment 11, wherein the condition is passage of time, temperature, pH, water content of the fluid, osmolality of the fluid, salt concentration of the fluid, additive concentration of the fluid, or a combination comprising at least one of the foregoing conditions.

### Embodiment 13

The fluid of any one or more of the preceding embodiments, wherein the carrier fluid is present in an amount of about 90 to about 99.95 wt %, and the crosslinked synthetic polymer is present in an amount of about 0.05 wt % to about 10 wt %, based on the total weight of the carrier fluid and the synthetic polymer.

### Embodiment 14

The fluid of any one or more of the preceding embodiments, wherein the synthetic polymer comprises a backbone comprising repeat units derived from (meth)acrylamide, N-(C₁-C₈ alkyl)acrylamide N,N-di(C₁-C₈ alkyl)acrylamide, vinyl alcohol, allyl alcohol, vinyl acetate, acrylonitrile, (meth)acrylic acid, ethacrylic acid, α-chloroacrylic acid, β-cyanoacrylic acid, β-methylacrylic acid (crotonic acid), α-phenylacrylic acid, β-acryloyloxypropionic acid, maleic acid, maleic anhydride, fumaric acid, itaconic acid, sorbic acid, α-chlorosorbic acid, 2′-methylisocrotonic acid, 2-acrylamido-2-methylpropane sulphonic acid, allyl sulphonic acid, vinyl sulphonic acid, allyl phosphonic acid, vinyl phosphonic acid, a corresponding salt of any of the foregoing, (C₁₋₃ alkyl) (meth)acrylate, (hydroxy-C₁₋₆ alkyl) (meth)acrylate, (dihydroxy-C₁₋₆ alkyl) (meth)acrylate, (trihydroxy-C₁₋₆ alkyl) (meth)acrylate, diallyl dimethyl ammonium chloride, N,N-di-(C₁₋₆ alkyl)amino (C₁₋₆ alkyl) (meth)acrylate, 2-ethyl-2-oxazoline, (meth)acryloxy(C₁₋₆ alkyl) tri(C₁₋₆ alkyl)ammonium halide), 2-vinyl-1-methylpyridinium halide), 2-vinylpyridine N-oxide), 2-vinylpyridine, or a combination comprising at least one of the foregoing.

### Embodiment 15

The fluid of any one or more of the preceding embodiments, wherein the synthetic polymer comprises a backbone comprising repeat units derived from (meth)acrylamide.

### Embodiment 16

The fluid of any one or more of the preceding embodiments, wherein the synthetic polymer is a superabsorbent polymer.

### Embodiment 17

The fluid of any one or more of the preceding embodiments, wherein the labile group comprises ester groups, amide groups, carbonate groups, azo groups, disulfide groups, orthoester groups, acetal groups, etherester groups, ether groups, silyl groups, phosphazine groups, urethane groups, esteramide groups, etheramide groups, anhydride groups, or a combination comprising at least one of the foregoing groups.

### Embodiment 18

The fluid of any one or more of the preceding embodiments, wherein the polymer comprises a crosslinker.

### Embodiment 19

The fluid of embodiment 18, wherein the crosslinker is a metallic crosslinker comprising zirconium, aluminum, titanium, chromium, or a combination comprising at least one of the foregoing.

### Embodiment 20

The fluid of embodiment 18, wherein the crosslinker is an organic crosslinker comprising a phenol-containing group, an aldehyde-containing group, a phenol-generating group, an aldehyde-generating group, or a combination comprising at least one of the foregoing.

### Embodiment 21

The fluid of any one or more of the preceding embodiments, further comprising a breaker package comprising a breaking agent.

### Embodiment 22

The fluid of embodiment 21, wherein the breaker package further comprises a breaker catalyst.

### Embodiment 23

The fluid of any one or more of the preceding embodiments, further comprising a proppant.

### Embodiment 24

The fluid of any one or more of the preceding embodiments, further comprising an additive, wherein the additive is a pH agent, a buffer, a mineral, an oil, an alcohol, a biocide, a clay stabilizer, a surfactant, a viscosity modifier, an emulsifier, a non-emulsifier, a scale-inhibitor, a fiber, a fluid loss control agent, or a combination comprising at least one of the foregoing.

### Embodiment 25

The fluid of any one or more of the preceding embodiments, wherein the fluid is devoid of a breaker package.

### Embodiment 26

A temporary plug comprising the fluid of any one or more of embodiments 1-25.

### Embodiment 27

The temporary plug of embodiment 26, wherein the temporary plug is used in a diversion treatment of a hydrocarbon-bearing formation.

### Embodiment 28

The temporary plug of embodiment 26, wherein the temporary plug is used for water and/or gas shut off in a hydrocarbon-bearing formation during a treatment.

### Embodiment 29

A method for temporarily plugging at least a portion of a hydrocarbon-bearing formation, the method comprising, injecting the fluid of any one or more or embodiments 1-25 into the formation during a treatment; forming a temporary plug comprising the fluid of any one or more or embodiments 1-25; subjecting the temporary plug to a condition that results in breaking the fluid; and recovering the broken fluid.

### Embodiment 30

The method of embodiment 29, wherein the fluid comprises a non-aqueous carrier fluid, and the forming the temporary plug comprises injecting into the formation an aqueous fluid to initiate hydration and crosslinking of the polymer after a delay time.

### Embodiment 31

The method of embodiment 30, wherein the delay time is 5 minutes to 48 hours, preferably, 15 minutes to 24 hours, more preferably, 30 minutes to 12 hours, even more preferably, 1 hour to 6 hours.

### Embodiment 32

The method of any one or more of embodiments 29 to 31, further comprising injecting a fracturing fluid into the formation subsequent to forming the temporary plug, wherein the flow of the fracturing fluid is impeded by the plug and a surface area of the fracture is increased.

### Embodiment 33

The method of any one or more of embodiments 29 to 32, wherein subjecting the temporary plug to a condition that results in breaking of the fluid comprises injecting into the formation a breaker package comprising a breaking agent and optionally a breaker catalyst to break the fluid.

### Embodiment 34

The method of any one or more of embodiments 29 to 33, wherein the treatment is a stimulation treatment, a fracturing treatment, an acidizing treatment, a friction-reducing treatment, a diversion treatment, or a downhole completion operation.

All ranges disclosed herein are inclusive of the endpoints, and the endpoints are independently combinable with each other. “Combination” is inclusive of blends, mixtures, alloys, reaction products, and the like. The term “(meth)acryl” is inclusive of both acryl and methacryl. Furthermore, the terms “first,” “second,” and the like do not denote any order, quantity, or importance, but rather are used to denote one element from another. The terms “a” and “an” and “the” as used herein do not denote a limitation of quantity, and are to be construed to cover both the singular and the plural, unless otherwise indicated herein or clearly contradicted by context. “Or” means “and/or” unless otherwise indicated herein or clearly contradicted by context. In general, the invention can alternatively comprise, consist of, or consist essentially of, any appropriate components herein disclosed. The invention can additionally, or alternatively, be formulated so as to be devoid, or substantially free, of any components, materials, ingredients, adjuvants or species used in the prior art compositions or that are otherwise not necessary to the achievement of the function and/or objectives of the present invention. Embodiments herein can be used independently or can be combined.

All references are incorporated herein by reference.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

1. A fluid for temporarily plugging a hydrocarbon-bearing formation, the fluid comprising:
a carrier fluid; and
a crosslinked synthetic polymer, wherein the polymer comprises a labile group to degrade the polymer when exposed to a change in a condition of the fluid.

2. The fluid of claim 1, wherein the carrier fluid is an aqueous carrier fluid.

3. The fluid of claim 1, wherein the carrier fluid is a non-aqueous carrier fluid.

4. The fluid of claim 1, wherein the fluid has
a first viscosity after a first period of time subsequent to mixing of the polymer and the carrier fluid,
a second viscosity after a second period of time subsequent to the first period, and
a third viscosity after a third period of time subsequent to the second period,
wherein the second viscosity is higher than the first viscosity and the third viscosity; and
wherein the fluid has a first viscosity that is greater than the viscosity of the carrier fluid.

5. The fluid of claim 4, further wherein the third viscosity is less than or equal to the first viscosity.

6. The fluid of claim 4, wherein the third viscosity is greater than or equal to the first viscosity.

7. The fluid of claim 4, wherein a temporary plug is formed when the fluid has the second viscosity.

8. The fluid of claim 1, wherein
the maximum second viscosity at 20° C. is higher than the first viscosity at 20° C.; and
the third viscosity at 20° C. is lower than the maximum second viscosity at 20° C.

9. The fluid of claim 1, wherein the change in a condition of the fluid further decreases the third viscosity, wherein the condition is passage of time, temperature, pH, water content of the fluid, osmolality of the fluid, salt concentration of the fluid, additive concentration of the fluid, or a combination comprising at least one of the foregoing conditions.

10. The fluid of claim 1, wherein the carrier fluid is present in an amount of about 90 to about 99.95 wt %, and the crosslinked synthetic polymer is present in an amount of about 0.05 wt % to about 10 wt %, based on the total weight of the carrier fluid and the synthetic polymer.

11. The fluid of claim 1, wherein the synthetic polymer comprises
a backbone comprising repeat units derived from (meth)acrylamide, N-(C₁-C₈ alkyl)acrylamide N,N-di(C₁-C₈ alkyl)acrylamide, vinyl alcohol, allyl alcohol, vinyl acetate, acrylonitrile, (meth)acrylic acid, ethacrylic acid, α-chloroacrylic acid, β-cyanoacrylic acid, β-methylacrylic acid (crotonic acid), α-phenylacrylic acid, β-acryloyloxypropionic acid, maleic acid, maleic anhydride, fumaric acid, itaconic acid, sorbic acid, α-chlorosorbic acid, 2′-methylisocrotonic acid, 2-acrylamido-2-methylpropane sulphonic acid, allyl sulphonic acid, vinyl sulphonic acid, allyl phosphonic acid, vinyl phosphonic acid, a corresponding salt of any of the foregoing, (C₁₋₃ alkyl) (meth)acrylate, (hydroxy-C₁₋₆ alkyl) (meth)acrylate, (dihydroxy-C₁₋₆ alkyl) (meth)acrylate, (trihydroxy-C₁₋₆ alkyl) (meth)acrylate, diallyl dimethyl ammonium chloride, N,N-di-(C₁₋₆ alkyl)amino (C₁₋₆ alkyl) (meth)acrylate, 2-ethyl-2-oxazoline, (meth)acryloxy(C₁₋₆ alkyl) tri(C₁₋₆ alkyl)ammonium halide), 2-vinyl-1-methylpyridinium halide), 2-vinylpyridine N-oxide), 2-vinylpyridine, or a combination comprising at least one of the foregoing; and
a labile group comprising ester groups, amide groups, carbonate groups, azo groups, disulfide groups, orthoester groups, acetal groups, etherester groups, ether groups, silyl groups, phosphazine groups, urethane groups, esteramide groups, etheramide groups, anhydride groups, or a combination comprising at least one of the foregoing groups.

12. The fluid of claim 1, wherein the synthetic polymer comprises a backbone comprising repeat units derived from (meth)acrylamide.

13. The fluid of claim 1, wherein the synthetic polymer is a superabsorbent polymer.

14. The fluid of claim 1, wherein the polymer comprises
a metallic crosslinker comprising zirconium, aluminum, titanium, chromium, or a combination comprising at least one of the foregoing; or
an organic crosslinker comprising a phenol-containing group, an aldehyde-containing group, a phenol-generating group, an aldehyde-generating group, or a combination comprising at least one of the foregoing.

15. The fluid of claim 1, further comprising one or more of:
a breaker package comprising a breaking agent and, optionally, a breaker catalyst;
a proppant; and
an additive, wherein the additive is a pH agent, a buffer, a mineral, an oil, an alcohol, a biocide, a clay stabilizer, a surfactant, a viscosity modifier, an emulsifier, a non-emulsifier, a scale-inhibitor, a fiber, a fluid loss control agent, or a combination comprising at least one of the foregoing.

16. A temporary plug comprising the fluid of claim 1, wherein the temporary plug is used in a diversion treatment of a hydrocarbon-bearing formation or for water and/or gas shut off in a hydrocarbon-bearing formation during a treatment.

17. A method for temporarily plugging at least a portion of a hydrocarbon-bearing formation, the method comprising,
injecting the fluid of claim 1 into the formation during a stimulation treatment, a fracturing treatment, an acidizing treatment, a friction-reducing treatment, a diversion treatment, or a downhole completion operation;
forming a temporary plug comprising the fluid of claim 1;
subjecting the temporary plug to a condition that results in breaking the fluid; and
recovering the broken fluid.

18. The method of claim 17, wherein the fluid comprises a non-aqueous carrier fluid, and forming the temporary plug comprises injecting into the formation an aqueous fluid to initiate hydration and crosslinking of the polymer after a delay time, wherein the delay time is 5 minutes to 48 hours.

19. The method of claim 17, further comprising injecting a fracturing fluid into the formation subsequent to forming the temporary plug, wherein the flow of the fracturing fluid is impeded by the plug and a surface area of the fracture is increased.

20. The method of claim 17, wherein subjecting the temporary plug to a condition that results in breaking of the fluid comprises injecting into the formation a breaker package comprising a breaking agent and optionally a breaker catalyst to break the fluid.
